(19) United States
(12) Patent Application Publication
(10) Pub. No.: US 2026/0329966 A1
(43) Pub. Date: Oct. 22, 2026

(54) COMPUTE ARCHITECTURE FOR WEIGHT-STATIONARY MATRIX MULTIPLY OPERATIONS

(71) Applicant: OpenAI Opco, LLC, San Francisco, CA (US)

(72) Inventors: Amin FIROOZSHAHIAN, Mountain View, CA (US); Ramyad HADIDI, University Park, MD (US); Hamid Reza GHASEMI, Sunnyvale, CA (US); Nawab ALI, Bellingham, WA (US); Farshid HAJHASHEMI VARNOSFADERANI, Brossard (CA)

(73) Assignee: OpenAI Opco, LLC, San Francisco, CA (US)

(21) Appl. No.: 19/529,294

(22) Filed: Feb. 4, 2026

Related U.S. Application Data
(60) Provisional application No. 63/753,840, filed on Feb. 4, 2025.

(51) Int. Cl. G06F 17/16

(52) U.S. Cl. CPC G06F 17/16

(57) ABSTRACT

Matrix multiplication operations in computing systems face challenges in balancing computational throughput, memory bandwidth, and power efficiency. To address these challenges, the disclosed technology provides a computing system architecture including general matrix multiply (GEMM) engines configured to accelerate matrix multiplication operations. The GEMM engines employ a weight-stationary dataflow in which weight values remain stored in compute engines while activation values are streamed through the system. A quantization block converts activation values from a first format to a second, reduced-precision format, and an accumulator stores partial sums from a compute engine array. Each compute engine includes dual weight banks enabling concurrent weight loading and computation. The compute engine array includes multiple weight interfaces coupled with different subsets of columns for parallel weight distribution. In some embodiments, the computing system includes multiple compute tiles arranged into one or more domains for scalable deployment.

### CROSS-REFERENCE TO RELATED APPLICATIONS

.This application claims the benefit, pursuant to 35 U.S.C. § 119(e) and 37 C.F.R. § 1.78(a), of U.S. Provisional Application No. 63/753,840, filed Feb. 4, 2025. The disclosure of U.S. Provisional Application No. 63/753,840 is hereby incorporated by reference herein in its entirety.

### BACKGROUND

Artificial intelligence (AI) and machine learning applications demand unprecedented computational throughput, requiring massive data movement, rapid inference cycles, and sustained high-performance processing. To meet these requirements, matrix multiplication operations form the computational core of neural network layers, attention mechanisms, and other data parallel algorithms. As model sizes and dataset complexities continue to grow, the underlying hardware must perform billions of multiply-accumulate operations per second while maintaining energy efficiency and accuracy.

These workloads impose substantial demands on computing systems. Each processing element must support high data bandwidth and large computations while maintaining timing accuracy and power efficiency. In high-density configurations, such as server racks and compute nodes in data centers, multiple processing elements may operate in close proximity, compounding the memory bandwidth requirements and reducing the available resources for data movement. Efficient utilization of memory bandwidth and reduction of redundant data transfers therefore become critical considerations in the design of such computing systems.

Achieving consistent and scalable performance across matrix multiplication operations remains a central challenge in high-performance computing, as conventional architectures struggle to balance compute density, memory bandwidth, data format conversion, and power efficiency at scale. Conventional approaches to matrix multiplication in computing systems often face challenges in balancing computational throughput, memory bandwidth, and power efficiency. In many implementations, processing elements must repeatedly fetch weight values from external memory for each computation, resulting in high memory traffic and increased power consumption. Additionally, activation values are often processed in high-precision formats throughout the computation pipeline, limiting the achievable throughput and storage efficiency. These inefficiencies are amplified in AI workloads where matrix multiplication operations are frequent and memory bandwidth is a critical resource.

### SUMMARY

The disclosed technology provides benefits and/or solves one or more of the above-mentioned challenges through a computing system architecture that includes general matrix multiply (GEMM) engines configured to accelerate matrix multiplication operations. The GEMM engines employ a weight-stationary dataflow in which weight values remain stored in compute engines while activation values are streamed through the system, reducing redundant memory accesses and improving bandwidth utilization. A quantization block converts activation values from a first format to a second, reduced-precision format, enabling reduced-precision computation while maintaining numerical accuracy. An accumulator stores partial sums from the compute engine array, supporting efficient accumulation of results across multiple matrix multiplication operations.

The disclosed technology can minimize redundant memory traffic by storing weights locally within compute engines equipped with dual weight banks. This dual-bank configuration enables concurrent weight loading and computation, allowing new weights to be loaded into one bank while computations proceed using weights stored in another bank. The compute engine array may include multiple weight interfaces coupled with different subsets of columns, enabling parallel weight distribution across the array. Adder trees coupled with each column sum the outputs from compute engines, and the accumulated results are stored in the accumulator for subsequent operations or output.

In some implementations, the computing system includes multiple compute tiles arranged into one or more domains. The quantization block includes a pipeline configured to determine a maximum exponent for a group of activation values, subtract the maximum exponent from each activation value's exponent, and normalize the activation values. This block quantization approach allows multiple activation elements to share a common scale value, reducing storage requirements while preserving numerical accuracy. Through this combination of weight-stationary dataflow, dual weight banks, quantization pipeline, and accumulator architecture, the disclosed technology enables efficient matrix multiplication with improved throughput, reduced memory bandwidth, and enhanced power efficiency.

Further, in some implementations of the disclosed technology a computing system can include a processing system with one or more processors, a memory subsystem that includes at least one of a system-level cache and high-bandwidth memory (HBM), and a plurality of compute tiles. GEMM engines in the compute tiles are operatively coupled to the memory subsystem and include: (i) a compute engine array having a plurality of compute engines, (ii) a quantization block coupled to the compute engine array and configured to receive activation values and provide quantized activation values to the compute engine array, and (iii) an accumulator coupled with the compute engine array and configured to receive and store results from the compute engine array, including partial sums. In this configuration, storing weights and performing computation within the compute tiles can reduce repeated accesses to external memory and reduce data movement through the memory subsystem, thereby improving memory bandwidth utilization and lowering power consumption. The quantization block can enable reduced-precision processing of activation values, which can increase effective compute throughput and reduce storage and transfer bandwidth while maintaining numerical accuracy for matrix multiplication workloads.

In some implementations, disclosed systems may perform a method for performing matrix multiplication. The method includes storing weights in compute engines of the compute engine array, receiving activation values, quantizing the activation values from a first format to a second format using the quantization block, computing products of the quantized activation values and the weights using the compute engine array, and accumulating results in the accumulator. In addition, compute engines include a first weight bank configured to store a first set of weights, a second weight bank configured to store a second set of weights, a multiply unit coupled with the first and second weight banks and configured to perform a multiplication operation, and an output configured to provide a result of the multiplication operation, enabling matrix multiplication results to be generated and accumulated efficiently within the GEMM engine.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1A illustrates a diagram of an example of a computing system with a system-on-chip (SoC) including multiple domains, wherein each domain includes compute tiles and high-bandwidth memory (HBM), in accordance with some aspects of the present technology.

FIG. 1B illustrates a diagram of an example of a compute tile including a GEMM engine, local memory, and DMA engine, in accordance with some aspects of the present technology.

FIG. 2 illustrates a diagram of an example of a GEMM engine architecture including a compute engine array, quantization block, and accumulator, in accordance with some aspects of the present technology.

FIG. 3 illustrates a diagram of an example of a compute engine array with weight interfaces and adder trees, in accordance with some aspects of the present technology.

FIG. 4 illustrates a diagram of an example of a compute engine with dual weight banks, in accordance with some aspects of the present technology.

FIG. 5 illustrates a diagram of an example of a quantization pipeline, in accordance with some aspects of the present technology.

FIG. 6 illustrates a flow chart of an example of a method for performing matrix multiplication, in accordance with some aspects of the present technology.

### DETAILED DESCRIPTION

The following disclosure provides various embodiments and examples for implementing features of the invention. Specific examples of components and arrangements are described to simplify the present disclosure. These examples are not intended to be limiting. For instance, the formation of a first feature over or on a second feature may include embodiments in which the two features are in direct contact, as well as embodiments in which additional features are interposed between them. Reference numerals and/or letters may be repeated across examples for clarity and simplicity, and such repetition does not imply a specific relationship between embodiments.

Some of the disclosed embodiments are described with reference to the accompanying drawings. However, it will be understood by those skilled in the art that the principles of the example methods and systems may be practiced without every specific detail. Well-known methods, procedures, and components have not been described in detail so as not to obscure the principles of some of the disclosed methods and systems. Unless explicitly stated, the example methods and processes described herein are neither constrained to a particular order or sequence nor constrained to a particular system configuration. Additionally, some of the described methods and systems or elements thereof can occur or be performed (e.g., executed) simultaneously, at the same point in time, or concurrently. Reference will now be made in detail to some of the disclosed methods and systems, examples of which are illustrated in the accompanying drawings.

It is to be understood that both the foregoing general description and the following detailed description are only explanatory and are not restrictive of this disclosure. The accompanying drawings, which are incorporated in and constitute a part of this specification, illustrate several disclosed methods and systems and together with the descriptions serve to outline principles of some of the disclosed methods and systems.

Spatially relative terms such as “beneath,” “below,” “lower,” “above,” “upper,” and similar descriptors are used for convenience in describing the relative positioning of elements as illustrated in the figures. These terms are intended to encompass different orientations of the device in use or operation, and should not be interpreted as limiting the scope of the invention to the depicted orientation.

Modern artificial intelligence (AI) applications, particularly large language model (LLM) workloads, demand substantial computational throughput for inference operations. General matrix multiply (GEMM) operations are fundamental computations for many neural network computations, including fully connected layers and attention mechanisms. As model sizes continue to grow, computing systems must efficiently execute large-scale matrix multiplication operations while managing data movement between processing elements and memory subsystems.

Efficient LLM inference acceleration requires addressing several challenges, including compute efficiency, specialized numeric formats, and memory access patterns. Data center applications in particular benefit from architectures that minimize data movement while maximizing computational throughput. Accordingly, there is a need for computing architectures that integrate matrix multiplication engines with optimized data paths and memory subsystems to accelerate inference workloads.

The disclosed technology provides a computing architecture for accelerating matrix multiplication operations in data center applications, particularly LLM inference workloads. The architecture employs a hierarchical organization including a system-on-chip (SoC) with multiple domains, where each domain includes multiple compute tiles and high-bandwidth memory (HBM). Each compute tile includes a GEMM engine integrated with a processor core, local memory, and a direct memory access (DMA) engine. The GEMM engine comprises a compute engine (CE) array for performing matrix multiplication, a quantization block for converting activation values between data formats, and an accumulator for storing results. This architecture enables efficient compute operations with specialized numerics while minimizing data movement.

In one example, a computing system may include a processing system with one or more processors, a memory subsystem including a system-level cache and HBM, and multiple compute tiles. Each compute tile may include a GEMM engine operatively coupled to the memory subsystem. The GEMM engine may include a compute engine array with multiple compute engines arranged in rows and columns. The GEMM engine may further include a quantization block coupled to the compute engine array and configured to receive activation values and provide quantized activation values to the compute engine array. An accumulator may be coupled to the compute engine array and configured to receive and store results from the compute engine array. The compute tiles may be arranged into one or more domains, where each domain includes a network-on-chip for routing data among the compute tiles and a memory interface for coupling the compute tiles to the memory subsystem.

Each domain may serve as a unit of scaling in the computing system. A domain may include multiple compute tiles, connected via a ring network-on-chip that provides connectivity for routing data among the tiles. The domain may further include a memory controller coupled to an HBM stack and a memory-side cache for reducing memory access latency. The domain may also include die-to-die interconnects for communication between domains within a single chip and chip-to-chip interconnects for communication between multiple chips. This organization enables localized data movement between tiles and their associated HBM channels.

Each compute tile may serve as a unit of compute in the architecture. A tile may include a processor core with integrated custom logic, including a GEMM engine. The tile may further include local memory that is distinct from the memory subsystem. The local memory may be software-managed and may include multiple memory banks, accessible by the GEMM engine and a DMA engine. The tile may include an arbiter configured to provide fair access to the local memory among multiple requesters, including the GEMM engine and the DMA engine. The tile may be configured to map memory addresses to the memory banks using an address scrambling function to distribute accesses across the banks. The local memory may include error correction codes (ECC) for detecting and correcting errors. The tile may also include a tile interconnect for connecting the processor core, local memory, DMA engine, and other components within the tile.

In some aspects, the GEMM engine is configured to perform matrix multiplication operations using the compute engine array. The GEMM engine may perform a matrix multiplication of two matrices and store the results in the accumulator. The accumulator may also accumulate the result of a matrix multiplication operation with previously generated results. The GEMM engine may be configured to perform operations including loading weight values into the compute engine array, performing a matrix multiplication, performing a matrix multiply-accumulate operation, reading and writing the accumulator, and transferring data between the accumulator and vector registers. In addition to matrix multiplication, the GEMM engine may provide support for quantization operations, which may be combined with matrix multiplication operations or performed independently.

The compute engine array may include multiple compute engines arranged in rows and columns, such as a 4×4 array of compute engines. The compute engine array may include a first weight interface coupled to a first subset of the columns and a second weight interface coupled to a second subset of the columns. The first subset and the second subset may include alternating columns of the compute engine array, such that the first weight interface provides weight values to columns 0 and 2, while the second weight interface provides weight values to columns 1 and 3. The two weight interfaces may be active concurrently to allow parallel loading of weights into multiple columns. The compute engine array may further include an adder tree coupled to each column. After performing a vector-matrix multiply operation, compute engines in each column may add their individual outputs together using the adder tree. The adder tree may use a floating-point data format for its inputs and outputs. The outputs of the adder trees may be concatenated together to produce a full row of output before sending the output to the accumulator.

Each compute engine in the compute engine array may include a first weight bank configured to store a first set of weights and a second weight bank configured to store a second set of weights. Each compute engine may hold two sets of weight values, such as B0 and B1. The compute engine may include a multiply unit coupled to the first weight bank and the second weight bank, and the multiply unit may be configured to perform a multiplication operation between activation values and one of the stored weight sets. The compute engine may include an activation input coupled to the multiply unit and configured to receive activation values. A bank select input may be configured to select between the first weight bank and the second weight bank for the multiplication operation. The first weight bank may be configured to receive weights while the multiply unit performs the multiplication operation using weights stored in the second weight bank, enabling concurrent weight loading and computation.

The quantization block may be coupled to the compute engine array and configured to receive activation values and provide quantized activation values to the compute engine array. The quantization block may be configured to convert activation values from a first format to a second format. For example, the quantization block may receive activation values in a first data format, such as BF16, and convert the activation values to a second data format, such as a block floating-point format including MXFP8, MXFP6, or MXFP4. The quantization block may group the activation values into blocks, where elements within each block share a common scale value. The quantization block may include a pipeline with multiple stages. In the first stage, the pipeline may determine a maximum exponent for a group of the activation values. In the second stage, the pipeline may subtract the maximum exponent from an exponent of each of the activation values in the group. In the third stage, the pipeline may normalize the activation values in the group. The quantization block may be configured to generate a reduced-precision floating-point format by applying a scale and a rounding operation to the activation values. The quantization block may implement saturation behavior for special numeric values, subnormal handling, and a round-to- nearest ties-to-even rounding mode when generating the quantized activation values. The quantization block may be bypassed when the activation values are already in the second format.

The accumulator may be coupled to the compute engine array and configured to receive and store results from the compute engine array. The accumulator may have storage space to hold a matrix of results, such as a 128×128 matrix of floating-point elements. The accumulator may be configured to store partial sums from the compute engine array. The accumulator may include a row of adders that can add received input to values already stored in the accumulator storage, enabling accumulation of results over time. The compute engine array may be configured to perform matrix multiplication using a tiled computation in which a first matrix is partitioned into first blocks and a second matrix is partitioned into second blocks. The accumulator may be configured to store partial sums corresponding to at least one block-level result. The accumulator may be configured to support segmented access to stored results. Each row of the accumulator may be divided into segments, such as four segments per row. The accumulator may include a mask value for selectively enabling or disabling readout of one or more segments of an accumulator row. When a segment is masked as disabled for a read operation, the accumulator may return zero values for the disabled segment.

In yet some other aspects, the disclosed technology may be directed to a method for performing matrix multiplication. The method may include storing weight values in compute engines of a compute engine array, receiving activation values at a quantization block, quantizing the activation values from a first format to a second format, computing products between the quantized activation values and the stored weight values, and accumulating results from the compute engines in an accumulator. The GEMM engine may employ a weight-stationary dataflow in which the weight values remain stored in the compute engines while successive sets of activation values are streamed through the compute engine array.

Other aspects of the disclosure may be directed to a compute engine for use in a matrix multiplication system, having the features described above including a first weight bank, a second weight bank, a multiply unit, an activation input, a bank select input, and an output coupled to the multiply unit.

Reference is now made to the drawings, which depict illustrative, non-limiting examples provided to facilitate understanding of the subject matter disclosed. The figures are not drawn to scale and are presented for explanatory purposes. Like reference numerals refer to like elements throughout the views. Features shown in connection with a particular figure or embodiment may be combined with, substituted for, or omitted relative to features shown in other figures. Certain conventional elements may be simplified or not shown to avoid obscuring pertinent details. Positional terms (e.g., “upper,” “lower,” “front,” “rear”) are used for convenience of description and do not imply a required orientation. Flow diagrams may represent operations that can be performed in different orders, in parallel, with steps added or omitted.

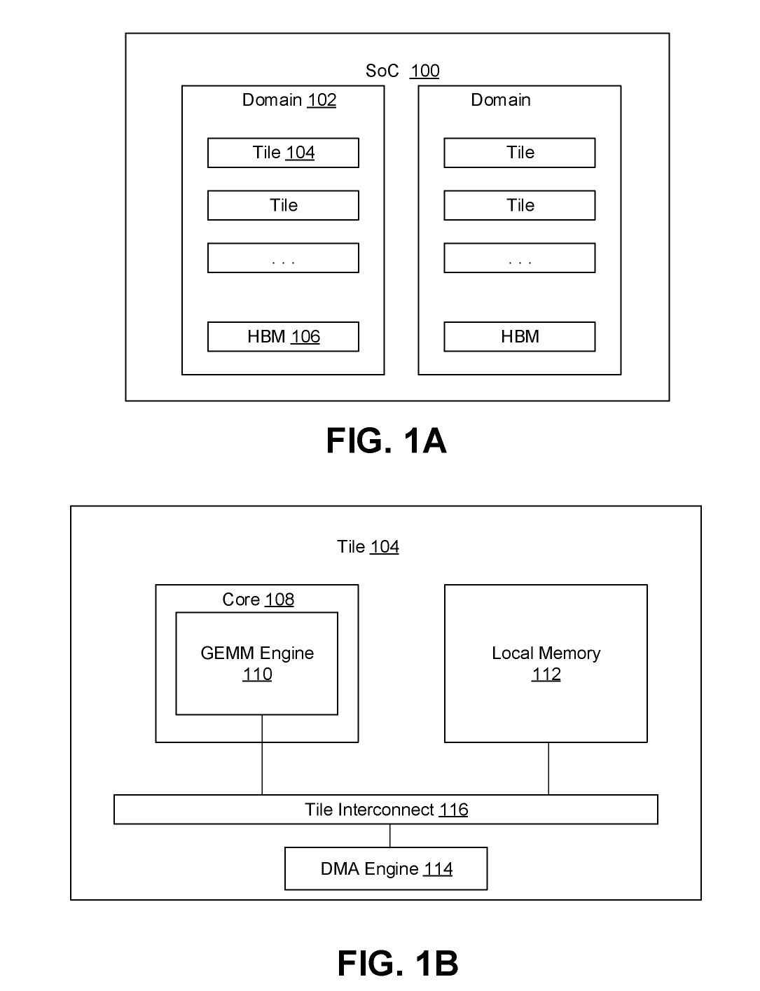

FIG. 1A illustrates a diagram of an example of a computing system including a system-on-chip (SoC) 100 with multiple domains 102, compute tiles 104, and high-bandwidth memory (HBM) 106, in accordance with some aspects of the present technology. The computing system disclosed in FIG. 1A illustrates a multi-domain architecture, but this is just an example and alternative arrangements are possible.

As shown in FIG. 1A, SoC 100 may include multiple domains 102 connected to each other. In some implementations, SoC 100 may include 4 to 8 domains 102. SoC 100 may be configured to target data center applications, specifically LLM inference workloads. SoC 100 may provide computational throughput in the range of 2 to 4 GEMM peta operations per second at a clock frequency of one gigahertz. The domains 102 within SoC 100 may be connected via die-to-die interconnects for communication between domains within a single chip. SoC 100 may also include chip-to-chip interconnects for communication between multiple chips in a multi-chip configuration.

Each domain 102 may serve as a unit of scaling in the SoC 100 architecture. Domain 102 may include multiple compute tiles 104, such as 16 tiles. Domain 102 may further include HBM 106, such as one HBM controller coupled to an HBM stack. HBM 106 may be configured to provide high-bandwidth memory access for the compute tiles 104, and may provide external memory storage for weight values, activation values, and computation results used by the GEMM engines within tiles 104. Domain 102 may also include a memory-side cache, such as a 64 megabyte cache, for reducing memory access latency. The tiles 104 within domain 102 may be connected via a ring network-on-chip that provides connectivity for routing data among the tiles 104. This organization enables localized data movement between tiles 104 and their associated HBM 106 channels.

Tiles 104 may be arranged within domain 102 and configured to perform compute operations. Each tile 104 may serve as a unit of compute in the architecture. As further described with reference to FIG. 1B, each tile 104 may include a processor core, a GEMM engine, local memory, and a DMA engine. The tiles 104 within a domain 102 may communicate with each other via the ring network-on-chip and may access HBM 106 through the memory interface of domain 102.

FIG. 1B illustrates a diagram of an example of a compute tile 104 including a core 108, a GEMM engine 110, local memory 112, a DMA engine 114, and a tile interconnect 116, in accordance with some aspects of the present technology. The tile 104 disclosed in FIG. 1B illustrates a single tile configuration, but this is just an example and alternative arrangements are possible.

As shown in FIG. 1B, tile 104 may include a core 108 coupled to tile interconnect 116. Core 108 may be a processor core with integrated custom logic, including GEMM engine 110. In some implementations, core 108 may include L1 and L2 caches for local data storage. Core 108 may be configured to execute instructions, including custom instructions for controlling GEMM engine 110 operations. The custom instructions may include weight load instructions, matrix multiply instructions, quantize instructions, and instructions for moving data between an accumulator and vector registers.

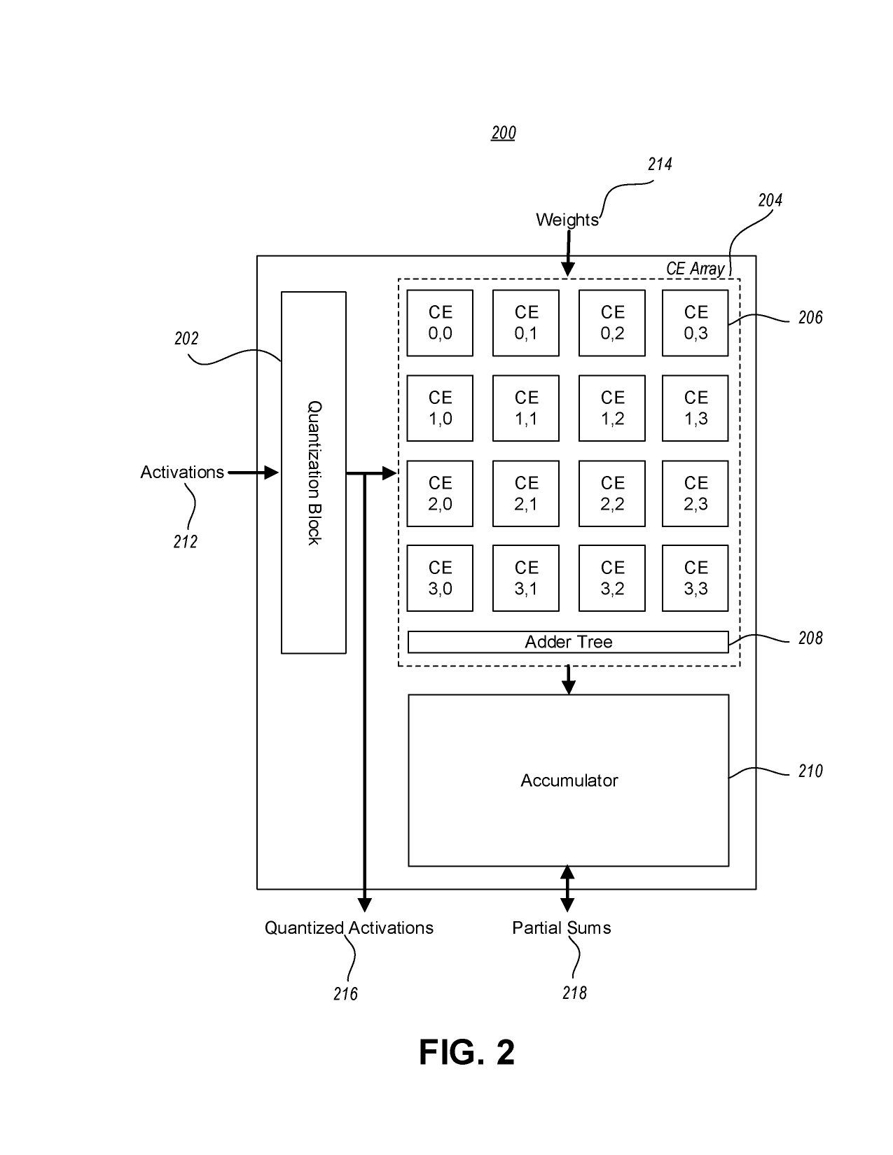

GEMM engine 110 may be integrated within core 108 and coupled to tile interconnect 116. GEMM engine 110 may be configured to perform matrix multiplication operations within tile 104. As further described with reference to FIG. 2, GEMM engine 110 may include a compute engine (CE) array, a quantization block, and an accumulator. GEMM engine 110 may use custom memory ports for accessing memory and fetching operands. GEMM engine 110 may be configured to perform matrix multiplication of two matrices and store the results in the accumulator, or accumulate the results with previously generated values.

Local memory 112 may be coupled to tile interconnect 116 and configured to provide data storage for tile 104. Local memory 112 may serve as a staging area for data that is operated on by core 108 and GEMM engine 110. In some implementations, local memory 112 may have a capacity of one megabyte. Local memory 112 may be organized in multiple memory banks, such as 16 banks, to enable parallel access. Local memory 112 may be software managed and may be distinct from the memory subsystem including HBM 106. The usage model may include transferring data from external memories, such as HBM 106 or other tiles 104, to local memory 112, performing computation operations using GEMM engine 110, and sending results back to a destination location.

DMA engine 114 may be coupled to tile interconnect 116 and configured to transfer data between local memory 112 and external memories. DMA engine 114 may facilitate data movement between tile 104 and HBM 106, or between tile 104 and other tiles 104 within domain 102. DMA engine 114 may operate concurrently with GEMM engine 110, allowing data transfers to proceed concurrently with matrix multiplication operations. This concurrent operation may help minimize latency by prefetching data for subsequent operations.

FIG. 2 illustrates a diagram of an example of a GEMM engine 200 architecture including a compute engine array 204, a quantization block 202, and an accumulator 210, in accordance with some aspects of the present technology. The GEMM engine 200 disclosed in FIG. 2 illustrates one configuration, but this is just an example and alternative arrangements are possible.

As shown in FIG. 2, GEMM engine 200 may receive activation input 212 and weight input 214, and may produce partial sums output 218. GEMM engine 200 may be configured to perform matrix multiplication of two matrices, such as two 128×128 matrices, and store the results in accumulator 210. GEMM engine 200 may also be configured to accumulate the result of a matrix multiplication operation with previously generated results stored in accumulator 210. In addition to matrix multiplication, GEMM engine 200 may provide support for quantization operations, which may be combined with matrix multiplication operations or performed independently.

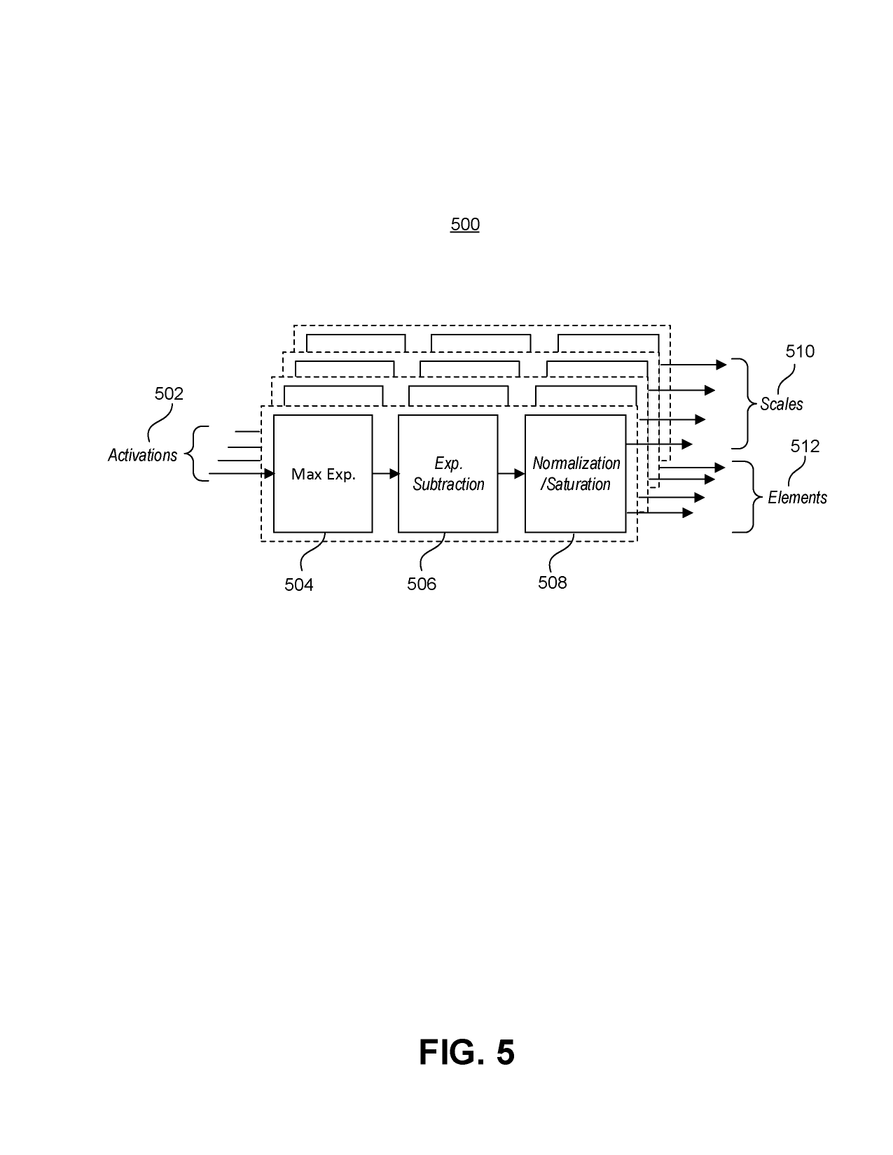

Activation input 212 may be received at quantization block 202. Quantization block 202 may be configured to receive activation input 212 in a first data format, such as BF16, and convert them to a second data format, such as a block floating-point format including MXFP8, MXFP6, or MXFP4. Quantization block 202 may output quantized activations 216 to compute engine array 204. In some implementations, if activation input 212 is already in the second data format, quantization block 202 may bypass the quantization operation and pass the activations directly to compute engine array 204. As further described with reference to FIG. 5, quantization block 202 may include a pipeline with multiple stages for performing the quantization operation.

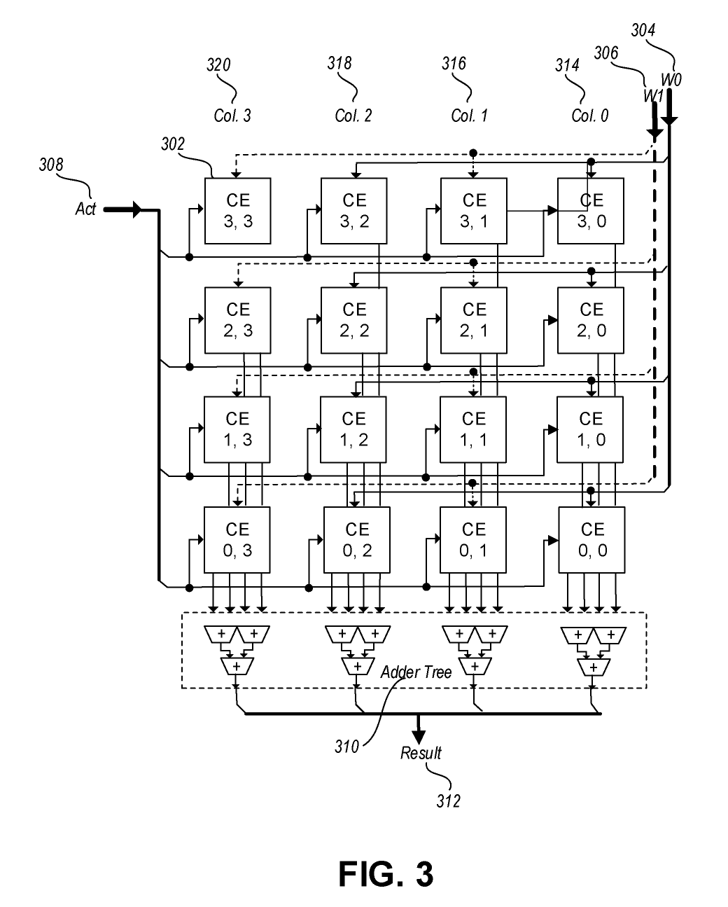

Weight input 214 may be provided to compute engine array 204 via weight interfaces. Compute engine array 204 may include multiple compute engines 206 arranged in rows and columns, such as a 4×4 array of compute engines 206. Each compute engine 206 may store weight values received via the weight interfaces. As further described with reference to FIG. 3, compute engine array 204 may include a first weight interface coupled to a first subset of columns and a second weight interface coupled to a second subset of columns. Compute engine array 204 may be configured to perform multiplication operations between the quantized activations 216 and the stored weight values.

Adder tree 208 may be coupled to compute engine array 204 and configured to receive outputs from the compute engines 206. After performing a vector-matrix multiply operation, the compute engines 206 in each column may add their individual outputs together using adder tree 208. Adder tree 208 may use a floating-point data format, such as FP32, for its inputs and outputs. The outputs of adder tree 208 may be concatenated together to produce a full row of output before sending the output to accumulator 210.

Accumulator 210 may be coupled to adder tree 208 and configured to receive and store results from compute engine array 204. Accumulator 210 may have storage space to hold a matrix of results, such as a 128×128 matrix of floating-point elements. Accumulator 210 may include a row of adders that can add received input to values already stored in accumulator 210, enabling accumulation of results over time. Accumulator 210 may output partial sums 218, which may be stored to memory or provided as results of the matrix multiplication operation.

The data flow through GEMM engine 200 may proceed as follows. Activation input 212 may be received and passed through quantization block 202 to produce quantized activations 216. Quantized activations 216 may be provided to compute engine array 204, where they are multiplied with stored weight values from weight input 214. The outputs from the compute engines 206 in each column may be summed by adder tree 208. The summed outputs may be provided to accumulator 210, which may store the results or accumulate them with previously stored values. The accumulated results may be output as partial sums output 218.

In some implementations, GEMM engine 200 can be included in a compute tile 104 (FIG. 1B) and is operatively coupled to a memory subsystem that includes at least one of a system-level cache and high-bandwidth memory (HBM) 106 (FIG. 1A). For example, a domain 102 (FIG. 1A) may include a network-on-chip configured to route data among compute tiles 104 and a memory interface configured to couple the compute tiles 104 to the memory subsystem, such that activation input 212 and weight input 214 for GEMM engine 200 are received from HBM 106 via the domain-level interconnect and memory interface. Within compute tile 104, GEMM engine 200 may access operands staged in local memory 112 (FIG. 1B), which may be distinct from the memory subsystem and software-managed. Local memory 112 may include a plurality of memory banks accessible by GEMM engine 200 and DMA engine 114, and an arbiter may be configured to provide fair access to local memory 112 among multiple requesters that include at least GEMM engine 200 and DMA engine 114. Further, compute tile 104 can map memory addresses to the plurality of memory banks using an address scrambling function to distribute accesses across the banks, and local memory 112 includes error correcting code (ECC) storage to support detection and correction of memory errors for activation values, weight values, and intermediate results staged for GEMM operations.

Further, GEMM engine 200 may be configurable to be controlled by a processor core (e.g., core 108 in FIG. 1B) to perform one or more operations including loading weight values into compute engine array 204 (e.g., via weight input 214), performing a matrix multiplication, performing a matrix multiply-accumulate operation using accumulator 210, storing accumulator contents, and transferring data between accumulator 210 and a register file (e.g., vector registers) of the processor. In some implementations, quantization block 202 quantizes activation input 212 according to a block-scaled numeric representation in which a plurality of activation elements share a common scale value, and generates a reduced-precision floating-point format by applying a scale and a rounding operation to the activation values, including implementing one or more of saturation behavior for special numeric values, subnormal handling, or a round-to-nearest ties-to-even rounding mode when generating quantized activations 216.

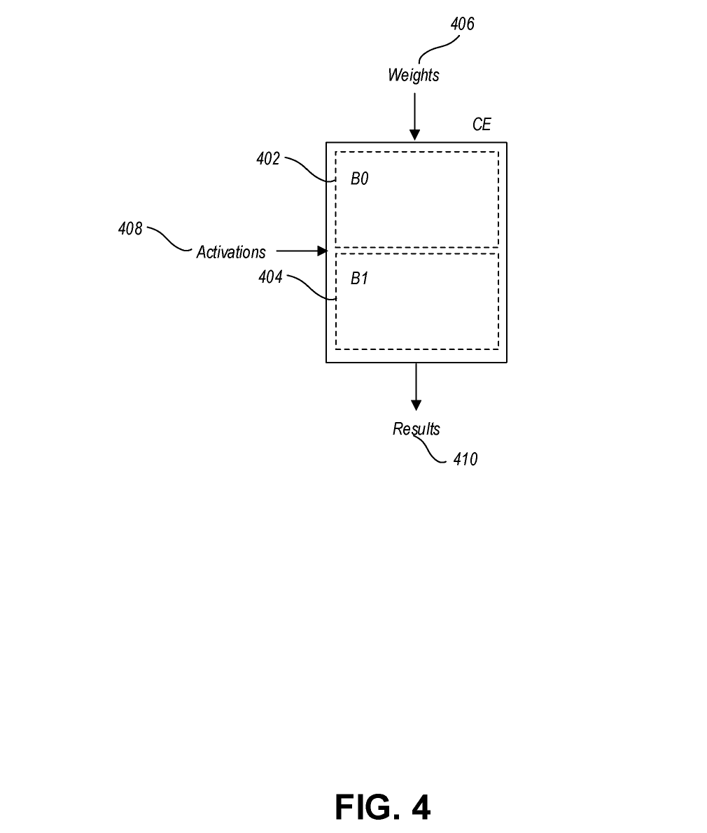

Compute engines 206 in compute engine array 204 may include storage for at least two sets of weight values (e.g., first and second weight banks as described with reference to FIG. 4), and compute engine array 204 may selectively use a first set of weight values or a second set of weight values to perform a matrix multiplication. Accumulator 210 may be configured to store partial sums corresponding to at least one block-level result of a tiled computation and, in some implementations, supports segmented access to stored results, including selectively enabling or disabling readout of one or more segments of an accumulator row based on a mask value such that, when a segment is masked as disabled for a read operation, accumulator 210 returns zero values for the disabled segment while providing partial sums output 218 for enabled segments.

In yet some other implementations, the plurality of compute tiles 104 (FIGS. 1A–1B) that include GEMM engine 200 can be arranged into one or more domains 102 (FIG. 1A). A given domain 102 may include a network-on-chip configured to route data among the compute tiles 104, such that activation input 212 and weight input 214 for GEMM engine 200 may be sourced from, or exchanged with, other compute tiles 104 via the network-on-chip. The domain 102 may further include a memory interface configured to couple the compute tiles 104 to the memory subsystem (e.g., at least one of a system-level cache and HBM 106), such that activation values and weight values can be fetched from the memory subsystem for delivery as activation input 212 and weight input 214. In this manner, GEMM engine 200 may operate as a tile-local matrix multiplication data path while the domain-level interconnect and memory interface support distribution of operands and collection of results (e.g., partial sums output 218) across tiles and between tiles and the memory subsystem.

FIG. 3 illustrates a diagram of an example of a compute engine array 300 with weight interfaces and adder trees, in accordance with some aspects of the present technology. The compute engine array 300 disclosed in FIG. 3 illustrates a 4×4 configuration, but this is just an example and alternative arrangements are possible.

As shown in FIG. 3, compute engine array 300 may include multiple compute engines 302 arranged in rows and columns. In the illustrated configuration, compute engine array 300 includes 16 compute engines 302 arranged in a 4×4 array. Compute engine array 300 may receive activation input 308 and weight values via first weight interface (W0) 304 and second weight interface (W1) 306. Compute engine array 300 may output result 312 after performing matrix multiplication operations.

First weight interface (W0) 304 may be coupled to a first subset of columns of compute engine array 300. Second weight interface (W1) 306 may be coupled to a second subset of columns of compute engine array 300. In the illustrated configuration, the first subset and the second subset may include alternating columns, such that first weight interface 304 provides weight values to first column (Column 0) 314 and third column (Column 2) 318, while second weight interface 306 provides weight values to second column (Column 1) 316 and fourth column (Column 3) 320. The two weight interfaces 304 and 306 may be active concurrently to allow parallel loading of weights into multiple columns.

Each compute engine 302 may be configured to store weight values and perform multiplication operations. As further described with reference to FIG. 4, each compute engine 302 may include dual weight banks for storing two sets of weight values. Compute engines 302 may receive activation input 308 and multiply the activation values with stored weight values. The compute engines 302 in each row of compute engine array 300 may receive the same activation values from activation input 308. At every cycle, each row of compute engine array 300 may perform a vector-matrix multiplication operation between an input vector of activation values and stored weights, producing an output row of results.

Adder tree 310 may be coupled to the bottom of each column of compute engine array 300. After performing a vector-matrix multiply operation, compute engines 302 in each column may add their individual outputs together using adder tree 310. Compute engine array 300 may include an adder tree 310 for each column, such that first column 314, second column 316, third column 318, and fourth column 320 each have an associated adder tree 310. Adder tree 310 may use a floating-point data format, such as FP32, for its inputs and outputs.

Result output 312 may be produced by concatenating the outputs of adder trees 310 from each column. The outputs of adder trees 310 from first column 314, second column 316, third column 318, and fourth column 320 may be concatenated together to produce a full row of result output 312. Result output 312 may be provided to an accumulator for storage or accumulation with previously generated results.

FIG. 4 illustrates a diagram of an example of a compute engine 400 with dual weight banks, in accordance with some aspects of the present technology. The compute engine 400 disclosed in FIG. 4 illustrates one configuration, but this is just an example and alternative arrangements are possible.

As shown in FIG. 4, compute engine 400 may include a first weight bank (B0) 402 and a second weight bank (B1) 404 for storing weight values. Compute engine 400 may receive weight input 406 for loading weights into the weight banks. Compute engine 400 may also receive activation input 408 and produce result output 410 after performing multiplication operations. Compute engine 400 may be one of multiple compute engines arranged in a compute engine array, such as compute engine array 300 described with reference to FIG. 3.

First weight bank (B0) 402 may be configured to store a first set of weights. Second weight bank (B1) 404 may be configured to store a second set of weights. Each weight bank 402, 404 may store weight values received via weight input 406. The dual weight bank configuration enables compute engine 400 to hold two sets of weight values simultaneously. In some implementations, weight values may be stored in a block floating-point format, such as MXFP6 or MXFP4. A bank select input may be configured to select between first weight bank 402 and second weight bank 404 for multiplication operations.

Weight input 406 may be coupled to first weight bank 402 and second weight bank 404. Weight input 406 may receive weight values from a weight interface of the compute engine array. In the illustrated configuration, weight values may be loaded into either first weight bank 402 or second weight bank 404 based on a bank select signal. First weight bank 402 may be configured to receive weights via weight input 406 while compute engine 400 performs multiplication operations using weights stored in second weight bank 404. This enables concurrent weight loading and computation, allowing new weights to be loaded while current computations proceed.

Activation input 408 may be coupled to a multiply unit within compute engine 400. Activation input 408 may receive quantized activation values from a quantization block of the GEMM engine. The multiply unit may be configured to perform a multiplication operation between activation values received via activation input 408 and weight values selected from one of first weight bank 402 or second weight bank 404. The multiply unit may multiply each activation value with a corresponding weight value from the selected weight bank.

Result output 410 may be coupled to the multiply unit and configured to provide results of the multiplication operations. Result output 410 may provide the multiplication results to an adder tree of the compute engine array. As described with reference to FIG. 3, the results from multiple compute engines in each column may be summed by an adder tree to produce a column output. Result output 410 may carry the individual multiplication results from compute engine 400 to be combined with results from other compute engines in the same column.

FIG. 5 illustrates a diagram of an example of a quantization pipeline 500, in accordance with some aspects of the present technology. The quantization pipeline 500 disclosed in FIG. 5 illustrates one configuration, but this is just an example and alternative arrangements are possible.

As shown in FIG. 5, quantization pipeline 500 may receive activations 502 as input and produce scales 510 and elements 512 as outputs. Quantization pipeline 500 may be included within a quantization block of a GEMM engine, such as quantization block 202 described with reference to FIG. 2. Quantization pipeline 500 may be configured to convert activation values from a first data format, such as BF16, to a second data format, such as a block floating-point format including MXFP8, MXFP6, or MXFP4.

Activations 502 may be received at quantization pipeline 500 for quantization processing. Activations 502 may include activation values in a first data format, such as BF16. The activation values may be organized into groups, such as groups of 32 elements, for block quantization. Each group of activation values may be processed through quantization pipeline 500 to produce quantized output values that share a common scale.

Max exponent stage 504 may be configured as a first stage of quantization pipeline 500. Max exponent stage 504 may be configured to determine a maximum exponent for a group of activation values from activations 502. The maximum exponent may be identified by comparing the exponents of all activation values within the group. The maximum exponent determined at stage 504 may be used as a shared scale value for the group of activation values.

Exponent subtraction stage 506 may be configured as a second stage of quantization pipeline 500, coupled to max exponent stage 504. Exponent subtraction stage 506 may be configured to subtract the maximum exponent determined at stage 504 from an exponent of each of the activation values in the group. This subtraction operation may normalize the exponents of the activation values relative to the maximum exponent, producing adjusted exponent values for each activation in the group.

Normalization/saturation stage 508 may be configured as a third stage of quantization pipeline 500, coupled to exponent subtraction stage 506. Normalization/saturation stage 508 may be configured to normalize the activation values in the group based on the adjusted exponents from stage 506. Stage 508 may also implement saturation behavior for special numeric values, such as infinity or NaN values. Stage 508 may further implement subnormal handling and a round-to-nearest ties-to-even rounding mode when generating the quantized output values.

Scales 510 and elements 512 may be produced as outputs of quantization pipeline 500. Scales 510 may include the shared scale values determined from the maximum exponents at stage 504. In some implementations, scales 510 may be 8-bit scale values shared by groups of 32 elements. Elements 512 may include the quantized activation values produced by normalization/saturation stage 508. Elements 512 may be in a reduced-precision floating-point format, such as MXFP8, MXFP6, or MXFP4. The combination of scales 510 and elements 512 may represent the block quantized activation values to be provided to the compute engine array.

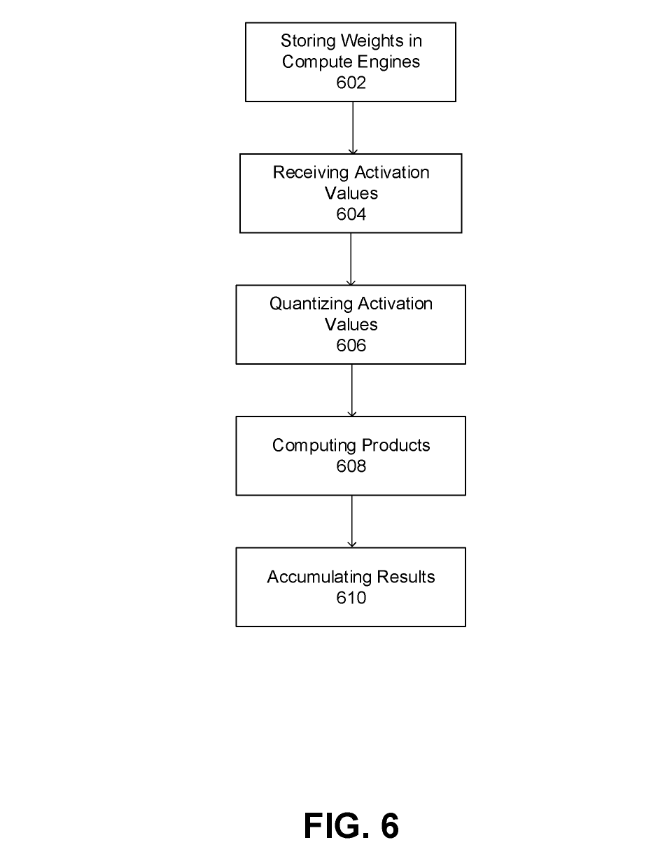

FIG. 6 illustrates a flow chart of an example of a method 600 for performing matrix multiplication, in accordance with some aspects of the present technology. The method 600 disclosed in FIG. 6 illustrates one sequence of operations, but this is just an example and alternative arrangements are possible. The operations may be performed in different orders, in parallel, or with steps added or omitted.

Method 600 may be performed by a GEMM engine, such as GEMM engine 200 described with reference to FIG. 2. Method 600 may include storing weights in compute engines at step 602, receiving activation values at step 604, quantizing activation values at step 606, computing products at step 608, and accumulating results at step 610. The GEMM engine may employ a weight-stationary dataflow in which weight values remain stored in the compute engines while consecutive sets of activation values are streamed through the compute engine array.

At step 602, weight values may be stored in compute engines of a compute engine array. The weight values may be loaded via weight interfaces, such as first weight interface 304 and second weight interface 306 described with reference to FIG. 3. The weight values may be stored in weight banks within each compute engine, such as first weight bank 402 or second weight bank 404 described with reference to FIG. 4. In some implementations, a first set of weights may be stored in a first weight bank while a second set of weights is stored in a second weight bank. The weight values may remain stored in the compute engines for multiple matrix multiplication operations in accordance with the weight-stationary dataflow.

For example, at step 602, GEMM engine 200 may store weight values in compute engines 206 of compute engine array 204 by issuing one or more weight-load operations that transfer weight values from memory subsystem resources (e.g., HBM 106) to the compute engine array. For example, DMA engine 114 (FIG. 1B) may transfer a block of weight values from HBM 106 to local memory 112, and GEMM engine 200 may read the weight values from local memory 112 and drive the weight values as weight input 214 (FIG. 2) to compute engine array 204. In some implementations, the weight values can be distributed through one or more weight interfaces, such as first weight interface (W0) 304 and second weight interface (W1) 306 (FIG. 3), which may be concurrently active to load different subsets of columns of compute engine array 300. Each compute engine 400 (FIG. 4) may write received weight values into one of first weight bank (B0) 402 or second weight bank (B1) 404 based on a bank select input. In one example, while multiply operations use weight values stored in second weight bank 404, additional weight values are loaded through weight input 406 into first weight bank 402, and thereafter the bank select input may be changed to begin using the newly loaded weight values.

At step 604, activation values may be received at a quantization block of the GEMM engine. The activation values may be received from local memory or from an external memory such as HBM. The activation values may be in a first data format, such as BF16, or may already be in a quantized format such as MXFP8, MXFP6, or MXFP4. Consecutive rows of activation values may be supplied to the GEMM engine for matrix multiplication operations.

For example, at step 604, GEMM engine 200 may receive activation values as activation input 212 (FIG. 2) at quantization block 202. In some implementations, DMA engine 114 transfers consecutive rows (or other activation portions) from HBM 106 to local memory 112, and quantization block 202 reads the activation values from local memory 112 for processing. The activation values may be represented in a first data format (e.g., BF16) or may already be represented in a reduced-precision block floating-point format (e.g., MXFP8, MXFP6, or MXFP4). In some implementations, activation values are supplied to quantization block 202 as a stream of activation elements corresponding to successive cycles of operation of compute engine array 204.

At step 606, the activation values may be quantized from a first format to a second format using the quantization block. The quantization may be performed using a quantization pipeline, such as quantization pipeline 500 described with reference to FIG. 5. The quantizing may include determining a maximum exponent for a group of activation values, subtracting the maximum exponent from an exponent of each of the activation values, and normalizing the activation values. In some implementations, if the activation values are already in the second format, step 606 may be bypassed and the activation values may be passed directly to the compute engine array.

For example, at step 606, quantization block 202 may quantize activation input 212 from a first format to a second format using quantization pipeline 500 (FIG. 5). For example, activations 502 may be processed in groups (e.g., groups of 32 elements) such that max exponent stage 504 determines a maximum exponent for a group, exponent subtraction stage 506 subtracts the maximum exponent from an exponent of each activation value in the group, and normalization/saturation stage 508 normalizes the activation values to produce block-quantized output values. Quantization pipeline 500 may output scales 510 and elements 512, where scales 510 include group scale values derived from the maximum exponents and elements 512 include reduced-precision activation values. In some implementations, normalization/saturation stage 508 applies saturation behavior for special numeric values, subnormal handling, and round-to-nearest ties-to-even rounding when generating elements 512. In some implementations, when activation input 212 is already provided in the second format, quantization block 202 bypasses one or more quantization operations and forwards the activation values to compute engine array 204 as quantized activations 216 (FIG. 2).

At step 608, products may be computed between the quantized activation values and the stored weight values using the compute engines. Each compute engine may multiply received activation values with weight values stored in a selected weight bank. The compute engines in each column of the compute engine array may produce individual multiplication results. The results from compute engines in each column may be summed using an adder tree to produce a column output. The column outputs may be concatenated to produce a full row of results.

For example, at step 608, compute engines 206 of compute engine array 204 compute products between quantized activations 216 and stored weight values. In some implementations, each compute engine 400 (FIG. 4) receives activation input 408 and performs multiplication using a multiply unit coupled to first weight bank 402 and second weight bank 404, with a bank select input

selecting which weight bank provides the weight values for the multiplication operation. Result output 410 from each compute engine 400 may be provided to an adder tree (e.g., adder tree 208 in FIG. 2 and/or adder tree 310 in FIG. 3) coupled with a column of the compute engine array to sum outputs from compute engines in that column, thereby producing a column output. The column outputs may be concatenated to form a row of results (e.g., result output 312 in FIG. 3) for delivery to accumulator 210 (FIG. 2).

At step 610, results from the compute engines may be accumulated in an accumulator. The accumulator may receive the row of results from the adder trees and store the results in internal storage. The accumulator may add received results to values already stored in the accumulator, enabling accumulation of partial sums from multiple matrix multiplication operations. The accumulated results may be stored to memory or provided as output of the matrix multiplication operation. Steps 604 through 610 may be repeated for consecutive rows of activation values while the weight values remain stored in the compute engines at step 602.

For example, at step 610, accumulator 210 receives the row of results from the adder tree(s) and stores the results in internal accumulator storage, which may hold a matrix of results (e.g., a 128×128 matrix of floating-point elements). In some implementations, accumulator 210 includes adders configured to add received results to values already stored in accumulator 210, thereby accumulating partial sums across multiple matrix multiplication operations that contribute to a same output region. After completing accumulation for a target output matrix (or tile thereof), accumulator 210 may output partial sums output 218 (FIG. 2) for storage to memory subsystem resources (e.g., local memory 112 and/or HBM 106) or for use by other operations.

In some implementations, steps 604 through 610 may be repeated for consecutive activation portions while the weight values loaded at step 602 remain stored in compute engines 206 in accordance with the weight-stationary dataflow.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

A number of implementations have been described. Nevertheless, it will be understood that various modifications may be made without departing from the spirit and scope of the disclosure. Accordingly, other implementations are within the scope of the following claims.

It is understood that the described systems or apparatuses are not mutually exclusive, and elements, components, materials, or steps described in connection with one example method, system, or apparatus may be combined with, or eliminated from, other disclosed methods, systems, or apparatuses in suitable ways to accomplish desired design objectives.

In the foregoing specification, the disclosed systems or apparatuses have been described with reference to numerous specific details that can vary from implementation to implementation. Certain adaptations and modifications of the described systems or apparatuses can be made. Various renditions of the disclosed systems or apparatuses can be apparent to those skilled in the art from consideration of the specification and practice of the invention disclosed herein. It is intended that the specification and examples be considered as exemplary only.

It should be understood that the various embodiments described herein are not mutually exclusive and may be combined, modified, or interchanged in whole or in part without departing from the scope of the disclosed technology. Features illustrated or described in connection with one embodiment may be incorporated into other embodiments to form additional implementations. For example, compute engine array configurations, weight interface arrangements, quantization pipeline stages, accumulator designs, and dataflow architectures, described with respect to any of FIGS. 1–6 may be selectively integrated to achieve desired matrix multiplication performance, memory efficiency or computational throughput. Accordingly, the disclosed technology encompasses all such combinations and variations that fall within the spirit and scope of the appended claims.

The present technology includes devices, apparatuses, and assemblies addressed in the aspects of the present technology presented below:

Aspect I: A computing system including:
a processing system including one or more processors;
a memory subsystem including at least one of a system‑level cache and high‑bandwidth memory (HBM);
a plurality of compute tiles;
general matrix multiply (GEMM) engines in the plurality of compute tiles and operatively coupled to the memory subsystem, the GEMM engines including:
   a compute engine array including a plurality of compute engines;
   a quantization block coupled to the compute engine array, the quantization block being configured to receive activation values and provide quantized activation values to the compute engine array; and
   an accumulator coupled with the compute engine array and configured to receive and store results from the compute engine array.

Aspect II: The computing system of Aspect I, wherein the compute engine array includes an array of compute engines arranged in a plurality of rows and a plurality of columns.

Aspect III: The computing system of Aspect II, wherein the GEMM engines further include:
a first weight interface coupled with a first subset of the plurality of columns; and
a second weight interface coupled with a second subset of the plurality of columns.

Aspect IV: The computing system of Aspect III, wherein the first subset of the plurality of columns and the second subset of the plurality of columns comprise alternating columns of the compute engine array.

Aspect V: The computing system of any of Aspects II-IV, wherein the GEMM engines further comprise an adder tree coupled with each column of the plurality of columns.

Aspect VI: The computing system of any of Aspects I-V, wherein each compute engine of the plurality of compute engines includes:
a first weight bank configured to store a first set of weights; and
a second weight bank configured to store a second set of weights.

Aspect VII: The computing system of Aspect VI, wherein each compute engine further includes a multiply unit coupled with the first weight bank and the second weight bank.

Aspect VIII: The computing system of any of Aspects I-VII, wherein the quantization block is configured to convert the activation values from a first format to a second format.

Aspect IX: The computing system of Aspect VIII, wherein the quantization block includes a pipeline including a plurality of stages, the pipeline configured to:
determine a maximum exponent for a group of the activation values;
subtract the maximum exponent from an exponent of each of the activation values in the group; and
normalize the activation values in the group.

Aspect X: The computing system of any of Aspects I-IX, wherein the accumulator is configured to store partial sums from the compute engine array.

Aspect XI: A method for performing matrix multiplication, the method including:
storing weights in a plurality of compute engines of a compute engine array;
receiving activation values;
quantizing the activation values from a first format to a second format using a quantization block;
computing, by the compute engine array, products of the quantized activation values and the weights; and
accumulating results in an accumulator.

Aspect XII: The method of Aspect XI, wherein storing weights comprises loading weights into a first weight bank of a compute engine while computing using weights stored in a second weight bank of the compute engine.

Aspect XIII: The method of any of Aspects XI-XII, wherein storing weights includes:
providing weights via a first weight interface to a first subset of the plurality of compute engines; and
providing weights via a second weight interface to a second subset of the plurality of compute engines.

Aspect XIV: The method of any of Aspects XI-XIII, wherein quantizing the activation values includes:
determining a maximum exponent for a group of the activation values;
subtracting the maximum exponent from an exponent of each of the activation values in the group; and
normalizing the activation values in the group.

Aspect XV: The method of any of Aspects XI-XIV, wherein quantizing the activation values is bypassed when the activation values are already in the second format.

Aspect XVI: The method of any of Aspects XI-XV, wherein the weights remain stationary in the plurality of compute engines while receiving a plurality of the activation values.

Aspect XVII: A compute engine including:
a first weight bank configured to store a first set of weights;
a second weight bank configured to store a second set of weights;
a multiply unit coupled with the first weight bank and the second weight bank, the multiply unit being configured to perform a multiplication operation; and
an output configured to provide a result of the multiplication operation.

Aspect XVIII: The compute engine of Aspect XVII, further including an activation input coupled with the multiply unit and configured to receive activation values.

Aspect XIX: The compute engine of any of Aspects XVII-XVIII, further including a bank select input configured to select between the first weight bank and the second weight bank for the multiplication operation.

Aspect XX: The compute engine of any of Aspects XVII-XIX, wherein the first weight bank is configured to receive weights while the multiply unit performs the multiplication operation using weights stored in the second weight bank.

Aspect XXI: The computing system of any of Aspects I-X, wherein the plurality of compute tiles are arranged into one or more domains, the one or more domains including:
a network-on-chip domain configured to route data among the compute tiles; and
a memory interface domain configured to couple the compute tiles to the memory subsystem.

Aspect XXII: The computing system of any of Aspects I-X and XXI, wherein the GEMM engines are configured to perform at least one of:
loading weight values into the compute engine array,
performing a matrix multiplication,
performing a matrix multiply-accumulate operation,
storing accumulator contents, or
transferring data between the accumulator and a register file of the one or more processor.

Aspect XXIII: The computing system of any of Aspects I-X and XXI-XXII, wherein:
the quantization block is configured to quantize the activation values according to a block-scaled numeric representation in which a plurality of activation elements share a common scale value;
the quantized activation values include values in a reduced-precision floating-point format, and
the quantization block is configured to generate the reduced-precision floating-point format by applying a scale and a rounding operation to the activation values.

Aspect XXIV: The computing system of any of Aspects I-X and XXI-XXIII, wherein
the plurality of compute engines include storage for at least two sets of weight values, and
the compute engine array is configured to selectively use a first set of weight values or a second set of weight values to perform a matrix multiplication.

Aspect XXV: The computing system of any of Aspects I-X and XXI-XXIV, wherein:
the compute engine array is configured to perform matrix multiplication using a tiled computation in which a first matrix is partitioned into first blocks and a second matrix is partitioned into second blocks;
the accumulator is configured to store partial sums corresponding to at least one block-level result;
the accumulator is configured to support segmented access to stored results, including selectively enabling or disabling readout of one or more segments of an accumulator row based on a mask value; and
the accumulator is configured, when a segment is masked as disabled for a read operation, to return zero values for the disabled segment.

Aspect XXVI: The computing system of any of Aspects I-X and XXI-XXV, wherein the quantization block is configured to implement at least one of:
saturation behavior for special numeric values, subnormal handling, or a round-to-nearest ties-to-even rounding mode when generating the quantized activation values.

Aspect XXVII: The computing system of any of Aspects I-X and XXI-XXVI, wherein:
the plurality of compute tiles includes a local memory that is distinct from the memory subsystem, the local memory being software-managed and comprising a plurality of memory banks accessible by at least one of the GEMM engines or a direct memory access (DMA) engine;
the plurality of compute tiles includes an arbiter configured to provide fair access to the local memory among a plurality of requesters that include at least one of the GEMM engines and the DMA engine;
the plurality of compute tiles is configured to map memory addresses to the plurality of memory banks using an address scrambling function to distribute accesses across the plurality of memory banks; and
the local memory includes error correcting code (ECC) storage.

What is claimed is:

1. A computing system, comprising:
a processing system including one or more processors;
a memory subsystem including at least one of a system‑level cache and high‑bandwidth memory (HBM);
a plurality of compute tiles;
general matrix multiply (GEMM) engines in the plurality of compute tiles and operatively coupled to the memory subsystem, the GEMM engines comprising:
a compute engine array comprising a plurality of compute engines;
a quantization block coupled to the compute engine array, the quantization block being configured to receive activation values and provide quantized activation values to the compute engine array; and
an accumulator coupled with the compute engine array and configured to receive and store results from the compute engine array.

2. The computing system of claim 1, wherein the compute engine array comprises an array of compute engines arranged in a plurality of rows and a plurality of columns.

3. The computing system of claim 2, wherein the GEMM engines further comprise:
a first weight interface coupled with a first subset of the plurality of columns; and
a second weight interface coupled with a second subset of the plurality of columns.

4. The computing system of claim 3, wherein the first subset of the plurality of columns and the second subset of the plurality of columns comprise alternating columns of the compute engine array.

5. The computing system of claim 2, wherein the GEMM engines further comprise an adder tree coupled with each column of the plurality of columns.

6. The computing system of claim 1, wherein each compute engine of the plurality of compute engines comprises:
a first weight bank configured to store a first set of weights; and
a second weight bank configured to store a second set of weights.

7. The computing system of claim 6, wherein each compute engine further comprises a multiply unit coupled with the first weight bank and the second weight bank.

8. The computing system of claim 1, wherein the quantization block is configured to convert the activation values from a first format to a second format.

9. The computing system of claim 8, wherein the quantization block comprises a pipeline comprising a plurality of stages, the pipeline configured to:
determine a maximum exponent for a group of the activation values;
subtract the maximum exponent from an exponent of each of the activation values in the group; and
normalize the activation values in the group.

10. The computing system of claim 1, wherein the accumulator is configured to store partial sums from the compute engine array.

11. A method for performing matrix multiplication, the method comprising:
storing weights in a plurality of compute engines of a compute engine array;
receiving activation values;
quantizing the activation values from a first format to a second format using a quantization block;
computing, by the compute engine array, products of the quantized activation values and the weights; and
accumulating results in an accumulator.

12. The method of claim 11, wherein storing weights comprises loading weights into a first weight bank of a compute engine while computing using weights stored in a second weight bank of the compute engine.

13. The method of claim 11, wherein storing weights comprises:
providing weights via a first weight interface to a first subset of the plurality of compute engines; and
providing weights via a second weight interface to a second subset of the plurality of compute engines.

14. The method of claim 11, wherein quantizing the activation values comprises:
determining a maximum exponent for a group of the activation values;
subtracting the maximum exponent from an exponent of each of the activation values in the group; and
normalizing the activation values in the group.

15. The method of claim 11, wherein quantizing the activation values is bypassed when the activation values are already in the second format.

16. The method of claim 11, wherein the weights remain stationary in the plurality of compute engines while receiving a plurality of the activation values.

17. A compute engine, comprising:
a first weight bank configured to store a first set of weights;
a second weight bank configured to store a second set of weights;
a multiply unit coupled with the first weight bank and the second weight bank, the multiply unit being configured to perform a multiplication operation; and
an output configured to provide a result of the multiplication operation.

18. The compute engine of claim 17, further comprising an activation input coupled with the multiply unit and configured to receive activation values.

19. The compute engine of claim 17, further comprising a bank select input configured to select between the first weight bank and the second weight bank for the multiplication operation.

20. The compute engine of claim 17, wherein the first weight bank is configured to receive weights while the multiply unit performs the multiplication operation using weights stored in the second weight bank.
